(19) United States
(12) Patent Application Publication
(10) Pub. No.: US 2025/0338991 A1
(43) Pub. Date: Nov. 6, 2025

(54) BEVERAGE-MAKING MACHINE WITH IMPROVED DISTRIBUTION SHOWERHEAD

(71) Applicant: Hamilton Beach Brands, Inc., Glen Allen, VA (US)

(72) Inventors: Richard Arena, Glen Allen, VA (US); Michael Garman, Glen Allen, VA (US); Ashley Shead, Glen Allen, VA (US)

(73) Assignee: Hamilton Beach Brands, Inc., Glen Allen, VA (US)

(21) Appl. No.: 18/652,492

(22) Filed: May 1, 2024

(51) Int. Cl. A47J 31/44; A47J 31/057; A47J 31/46

(52) U.S. Cl. CPC A47J 31/4478; A47J 31/057; A47J 31/465

(57) ABSTRACT

A beverage-making machine includes: a housing; a serving station that includes a showerhead, a brew basket, a dispensing outlet, and a receptacle platform; a water reservoir; and a heating unit fluidly connected with the water reservoir and with the showerhead. The showerhead includes a water distribution chamber in fluid connection with the heating unit. The showerhead includes a plurality of channels in a lower basin thereof, the channels extending radially outwardly. Each of the plurality of channels includes a plurality of holes, wherein at least one radially outward hole has a greater open area than a radially inward hole.

### FIELD OF THE INVENTION

The present invention relates generally to small appliances, and more specifically to beverage makers.

### BACKGROUND

Automatic drip coffeemakers are well known and widely used. They are effective at brewing carafes of coffee, typically containing five or more cups of liquid. Automatic drip coffee makers may also be used for brewing small batches (one to four cups).

A typical automatic drip coffeemaker includes a brew basket that contains ground coffee (presented loosely in a bowl-shaped filter or within a “pod”-type package often sold number the name “K-Cup® pods”). Heated water is conveyed to the brew basket and released, where it gravimetrically flows downwardly through the coffee grounds and into a receptacle such as a carafe or pot. Exemplary automatic drip coffeemakers are discussed in U.S. Pat. Nos. 5,001,969 to Moore et al.; 7,066,080 to Hsu; and 8,065,952 to Wang, the disclosures of which are hereby incorporated herein by reference in full. Some coffeemakers are designed to brew coffee in different forms; for example, coffeemakers offered in the FLEXBREW® line of products available from Hamilton Beach Brands (Richmond, Virginia), the current applicant, include an insert that enables the user to choose between a pod or loose ground coffee.

Moreover, another coffeemaker offered in the FLEXBREW® line of coffeemakers has two different “stations,” one of which can brew a full pot or carafe, and the other of which brews a single serving (often utilizing a pod as described above). This coffeemaker can provide the user with the flexibility of brewing either a single serving, if that is all that is desired, or multiple servings in a pot or carafe.

It may be desirable to provide performance improvements and flexibility to coffeemakers.

### SUMMARY

As a first aspect, embodiments of the invention are directed to a showerhead assembly for a beverage making machine. The showerhead assembly comprises a lower basin and a lid that overlies the lower basin to form a water distribution chamber. The assembly includes a plurality of channels in the lower basins, the channels extending radially outwardly. Each of the channels includes a plurality of holes, wherein at least one radially outward hole has a greater open area than a radially inward hole.

As a second aspect, embodiments of the invention are directed to a showerhead assembly for a beverage making machine comprising a lower basin and a cover that overlies the lower basin to form a water distribution chamber. The assembly includes a plurality of channels in the lower basin, the channels extending radially outwardly in a spiral pattern, each of the channels including a plurality of holes.

As a third aspect, embodiments of the invention are directed to a beverage-making machine comprising: a housing; a serving station that includes a showerhead, a brew basket, a dispensing outlet, and a receptacle platform; a water reservoir; and a heating unit fluidly connected with the water reservoir and with the showerhead. The showerhead comprises a water distribution chamber in fluid connection with the heating unit. The showerhead includes a plurality of channels in a lower basin thereof, the channels extending radially outwardly, each of the plurality of channels including a plurality of holes, wherein in at least one radially outward hole has a greater open area than a radially inward hole.

### BRIEF DESCRIPTION OF THE FIGURES

FIG. 1 is a front perspective view of a beverage making machine according to embodiments of the invention.

FIG. 2 is a front perspective view of the beverage making machine of FIG. 1 with the carafe removed.

FIG. 3 is a rear perspective view of the beverage making machine of FIG. 1 with the lower portion of the housing shown in broken line.

FIG. 4 is a rear top partial perspective view of the beverage making machine of FIG. 1 with the cover removed.

FIG. 5 is a side section view of the brew basket of the beverage making machine of FIG. 1.

FIG. 6 is a top view of the beverage making machine of FIG. 1 with the cover removed so that the showerhead is visible.

FIG. 7 is a bottom view of the shower head of FIG. 6.

FIG. 8 is a top perspective section view of the brew basket of the beverage making machine of FIG. 1 with the cover removed.

FIG. 9 is an exploded top perspective view of the showerhead and cover that comprise the showerhead assembly of the beverage making machine of FIG. 1.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the figures, certain layers, components or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

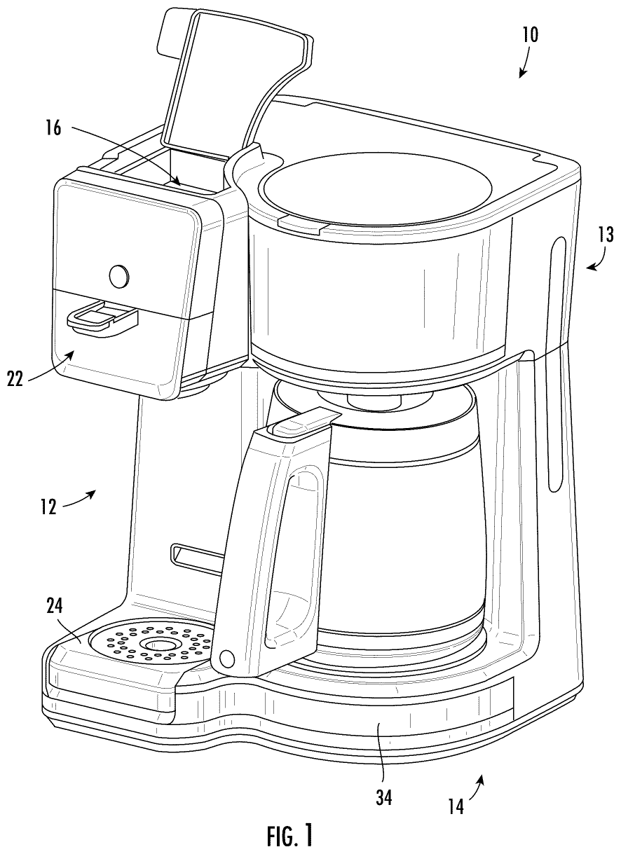

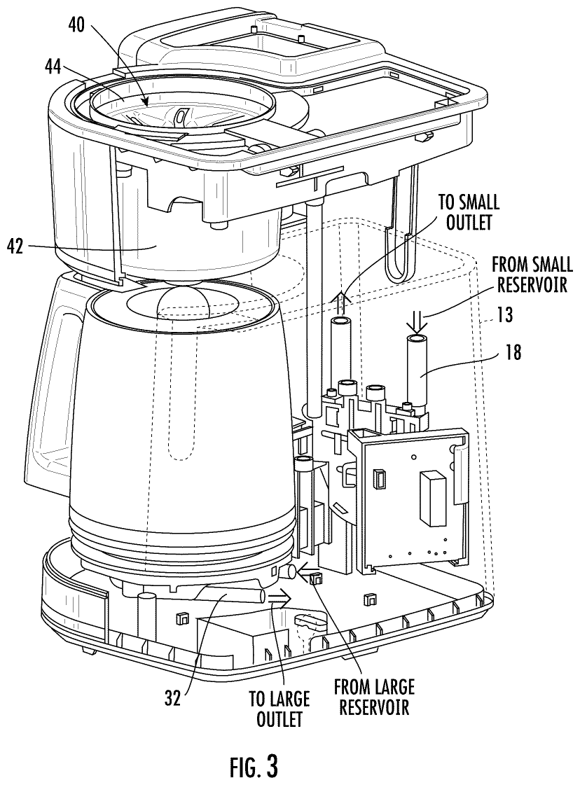

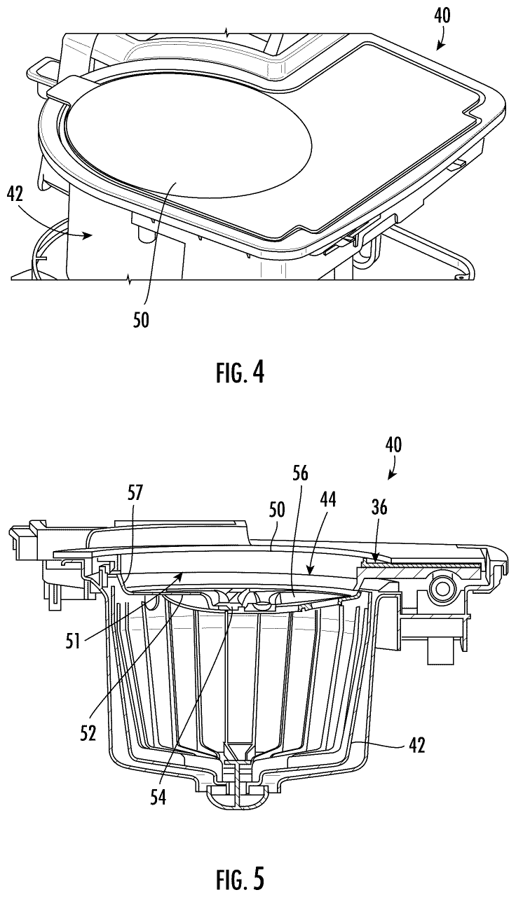

Referring now to FIG. 1, a schematic diagram of a coffeemaker, designated broadly at 10, is shown therein. The coffeemaker 10 includes a small serving station 12 and a large serving station 14 within a housing 13. The small serving station 12 includes a small water reservoir 16 located on and accessed from the upper portion of the coffeemaker 10, a U-shaped heating unit 18 (see FIG. 3) that is fluidly connected with the small water reservoir, and a water outlet that dispenses water into a small brew basket 22. A small serving platform 24 is located beneath the small brew basket 22. The small serving station 12 may be of conventional construction and need not be described in detail herein.

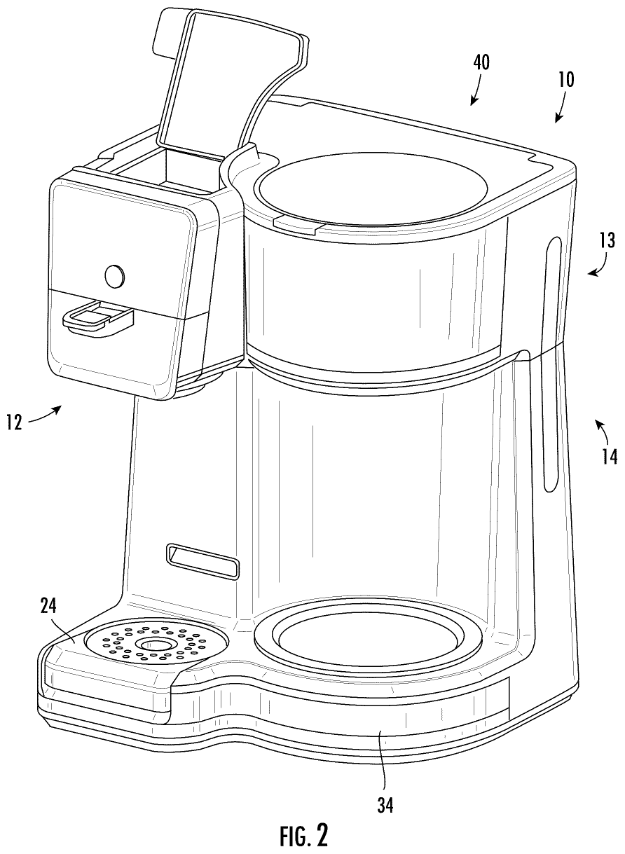

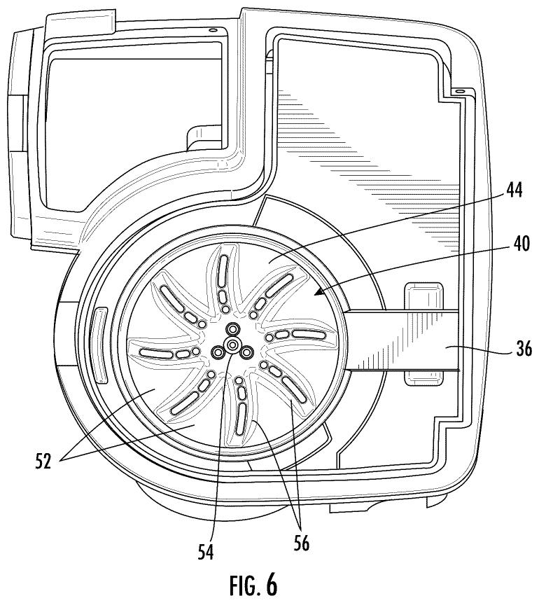

Referring to FIGS. 1 and 2, the large serving station 14 includes a large water reservoir (not shown) located in the rear of the coffeemaker 10. The large water reservoir is fluidly connected to a U-shaped heating unit 32 (see FIG. 3) that is located below a large serving platform 34. The heating unit 32 leads to a trough 36 (FIGS. 5 and 6) that in turns feeds a showerhead assembly 40. Water exiting the showerhead assembly 40 descends into the brew basket 42, where brewing of grounds occurs. Brewed liquid then drips from the brew basket 42 into a container (e.g., a pot or carafe 46) located on the large serving platform 34.

The reservoir, heating unit 32, brew basket 42, and large serving platform 34 may all be of conventional construction and operation and need not be described in detail herein. However, the showerhead assembly 40 is configured differently and can provide heretofore unachievable performance advantages. The showerhead assembly 40 is described in detail below.

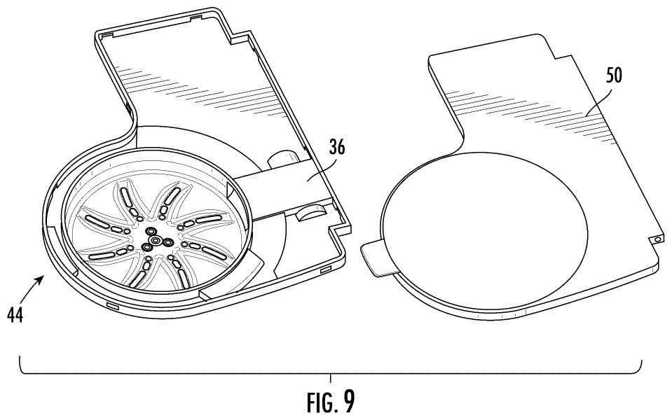

Referring to FIGS. 5-9, the showerhead assembly 40 includes a lower basin 44 that resides below a lid 50 that allows the user access to the brew basket 42. Together the lid 50 and the lower basin 44 define a chamber 51 that receives water from the trough 36. The showerhead assembly 40 (i.e., the lower basin 44 and the lid 50) are hingedly attached to the housing 13 and pivot together relative to the housing 13 to provide access to the brew basket 42 and to the large water reservoir.

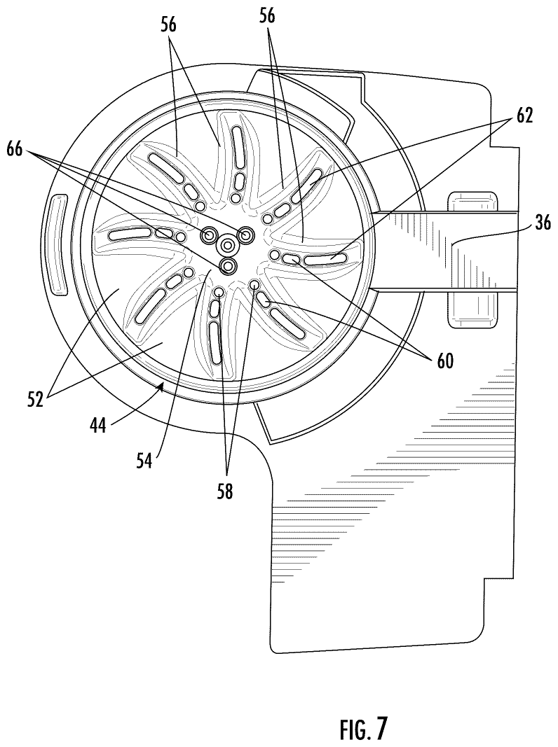

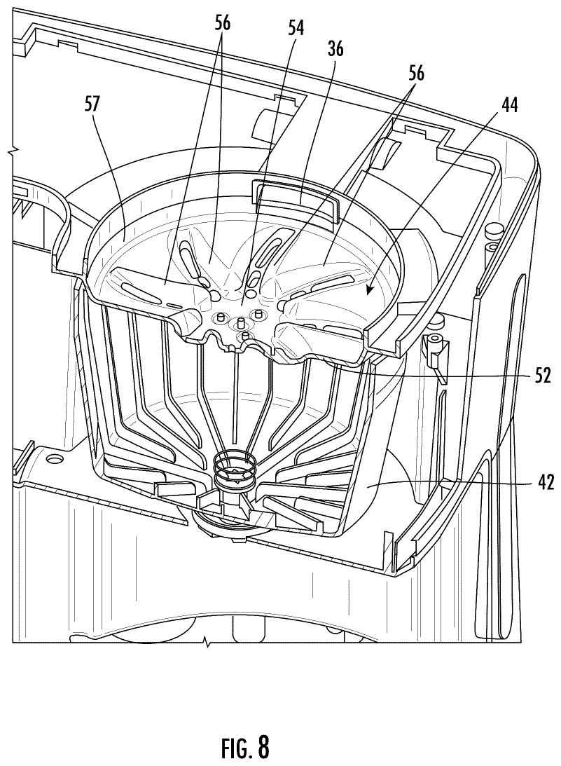

Referring now to FIGS. 5 and 8, the lower wall 52 of the lower basin 44 is generally planar. A central floor 54 is located slightly below the lower wall 52. Eight channels 56 originate and extend radially outwardly from the central floor 54 and have upper edges that merge with the lower wall 52 and a lower surface that merges with the central floor 54. In addition to extending radially from the central floor 54, each of the channels 56 curves slightly, such that together the channels 56 form a spiral or pinwheel pattern (see FIGS. 6 and 7). Side walls 57 extend upwardly from the outer edge of the lower basin 44 to meet the lid 50.

Referring now to FIGS. 6 and 7, it can be seen that each of the channels 56 includes three holes: a round hole 58 nearest the central floor 54; an oblong hole 60 that is radially outward of the round hole 58; and an elongated hole 62 that is radially outward of the oblong hole 60. As can be seen in FIG. 6, the oblong and elongated holes 60, 62 are of substantially the same width as the diameter of the round hole 58. However, the length of the oblong hole 60 is about 1.5 to 2.5 times the diameter of the round hole 58, and the length of the elongated hole is about 1.5 to 2.5 times the length of the oblong hole 60. Thus, the holes 58, 60, 62 increase significantly in open area with increasing distance from the central floor 54. There are also three holes 66 in the central floor 54.

During brewing of a beverage with the large serving station 14, as discussed above water is conveyed from the large water reservoir to the heating unit 32, where it is heated. The heated water is routed to the trough 36, which conveys the heated water to the chamber 51 of the showerhead assembly 40, where it collects on the central floor 54 of the lower basin 44.

Because the holes 66 in the central floor are relatively small, such that only a limited amount of water can flow through the holes 66 at any one time, the water collected on the central floor 54 tends to flow into the channels 56. Again, because the holes 58 in the channels 56 are relatively small, the water tends to continue to flow in the channels 56 toward the oblong holes 60 and, even more so, to the elongated holes 62. Because the elongated holes 62 and the oblong holes 60 have more open area than the round holes 58 and the holes 66, more water will tend to drip from these bigger holes 60, 62 into the grounds in the brew basket 42.

The aforementioned distribution of water drainage (i.e., more through the oblong and elongated holes 60, 62) can result in a more uniform distribution of water in the brew basket 42. Particularly when loose grounds are used in the brew basket 42, a heavy concentration of water in the center of the brew basket 42 can cause both (a) an uneven distribution of water throughout the grounds, which can cause uneven wetting of the grounds, and (b) the formation of a somewhat deep depression in the center of the grounds. Both of these issues can adversely affect the quality of the brewed coffee, as the saturation extent and time of the grounds can vary. These shortcomings can be lessened (or virtually eliminated) with the use of the showerhead 40.

Moreover, because the channels 56 are arranged in the aforementioned spiral pattern, the oblong holes 60 and the elongated holes 62 can be somewhat longer than would be the case if the channels 56 were simply straight (i.e., if the channels 56 were true radii). The resulting increased size of the oblong and elongated holes 60, 62 further helps to encourage more heated water to be dispersed farther away from the center of the brew basket 42.

Those of skill in this art will appreciate that the coffeemaker 10 may take other forms. For example, although the coffeemaker 10 is shown as having both small and large serving stations 12, 14, the coffeemaker may lack a small serving station 12, or may have a small serving station of a different configuration (e.g., an espresso station). The arrangement of the reservoirs and heating units may differ. Other variations may also be employed.

In addition, the configuration of the showerhead 40 may differ. For example, the showerhead assembly 40 may have more or fewer channels 56. Alternatively, the showerhead assembly 40 may have more or fewer holes in each channel. In some instances the channels 56 may define true radii (i.e., they do not define a spiral pattern) or they may define a more pronounced spiral pattern, or may define a zig-zag pattern. Other variations may also be suitable for use with embodiments of this invention.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

1. A showerhead assembly for a beverage making machine, comprising:
a lower basin; and
a cover that overlies the lower basin to form a water distribution chamber;
wherein the assembly includes a plurality of channels in the lower basin, the channels extending radially outwardly, each of the channels including a plurality of holes, wherein at least one radially outward hole has a greater open area than a radially inward hole.

2. The showerhead assembly defined in claim 1, wherein each hole of each channel has a greater open area than the immediately radially inward hole.

3. The showerhead assembly defined in claim 2, wherein each hole is of substantially the same width.

4. The showerhead assembly defined in claim 2, wherein the plurality of holes in each channel is three holes.

5. The showerhead assembly defined in claim 1, wherein the plurality of channels form a spiral pattern.

6. The showerhead assembly defined in claim 1, wherein the lower basin includes a central floor that is positioned below a lower surface, and wherein each of the plurality of channels originates from the central floor.

7. The showerhead assembly defined in claim 1, wherein the plurality of channels is at least four channels.

8. A showerhead assembly for a beverage making machine, comprising:
a lower basin; and
a cover that overlies the lower basin to form a water distribution chamber;
wherein the assembly includes a plurality of channels in the lower basin, the channels extending radially outwardly in a spiral pattern, each of the channels including a plurality of holes.

9. The showerhead assembly defined in claim 8, wherein each hole of each channel has a greater open area than the immediately radially inward hole.

10. The showerhead assembly defined in claim 9, wherein each hole is of substantially the same width.

11. The showerhead assembly defined in claim 9, wherein the plurality of holes in each channel is three holes.

12. The showerhead assembly defined in claim 8, wherein the lower basin includes a central floor that is positioned below a lower surface, and wherein each of the plurality of channels originates from the central floor.

13. The showerhead assembly defined in claim 8, wherein the plurality of channels is at least four channels.

14. A beverage-making machine, comprising:
a housing;
a serving station that includes a showerhead, a brew basket, a dispensing outlet, and a receptacle platform; and
a water reservoir;
a heating unit fluidly connected with the water reservoir and with the showerhead;
wherein the showerhead comprises a water distribution chamber in fluid connection with the heating unit;
wherein the showerhead includes a plurality of channels in a lower basin thereof, the channels extending radially outwardly, each of the plurality of channels including a plurality of holes, wherein in at least one radially outward hole has a greater open area than a radially inward hole.

15. The beverage-making machine defined in claim 14, wherein each hole of each channel has a greater open area than the immediately radially inward hole.

16. The beverage-making machine defined in claim 15, wherein each hole is of substantially the same width.

17. The beverage-making machine defined in claim 14, wherein the plurality of holes in each channel is three holes.

18. The beverage-making machine defined in claim 14, wherein the plurality of channels form a spiral pattern.

19. The beverage-making machine defined in claim 14, wherein the lower basin includes comprising a central floor that is positioned below a lower surface, and wherein each of the plurality of channels originates from the central floor.

20. The beverage-making machine defined in claim 14, wherein the plurality of channels is at least four channels.
